(19) United States
(12) Patent Application Publication
(10) Pub. No.: US 2026/0160698 A1
(43) Pub. Date: Jun. 11, 2026

(54) ULTRASONIC INDICATOR BASED ON EMULSION FORMATION

(71) Applicant: JP Laboratories, Inc., Middlesex, NJ (US)

(72) Inventors: Gordhanbhai N. Patel, Somerset, NJ (US); Julia Koleda Nordenbring, Bloomfield, NJ (US)

(21) Appl. No.: 18/724,871

(22) PCT Filed: Oct. 3, 2023
(86) PCT No.: PCT/US2023/034372

§ 371 Date: Jun. 27, 2024

(51) Int. Cl. G01N 21/78; B08B 3/12

(52) U.S. Cl. CPC G01N 21/78; B08B 3/12

(57) ABSTRACT

A device is provided for monitoring ultrasonic energy applied to an object. The device comprises a container comprising water and at least one composition selected from the group consisting of:
a water insoluble organic liquid as an emulsion aid and an oil; and
optionally a pH indicator and at least one of a nitro compound or a halo compound.

### FIELD OF THE INVENTION

The present invention is related to a system for monitoring the cleaning of an object with ultrasonic radiation. More specifically, the present invention provides a system for monitoring the formation of an opaque emulsion from a clear mixture of water, an oil and a water-insoluble, non-oil, organic liquid as an emulsion aid.

### BACKGROUND

Ultrasound waves are widely used for cleaning soiled objects and for various other applications. Ultrasonic cleaning, using aqueous fluids, is often used for final cleaning of precision components. Ultrasonic cleaning is advantageous in many applications because it is gentle but very invasive and therefore it is very effective on intricate parts; such as watches, valves, medical instruments, implants, circuit boards, etc. The frequencies used for cleaning typically range from about 20-200 kHz with frequencies of 80 kHz and 120 kHz typically used to clean machine parts.

Ultrasonic radiation relies on sound waves, which cause acoustic cavitation in the liquid. In acoustic cavitation, bubbles are formed and the bubbles grow until they implosively collapse in the liquid. The collapse of the bubbles is an almost adiabatic process resulting in the massive build-up of energy inside the bubble. The local effect is an extremely high temperature and pressure in a microscopic region of the sonicated liquid. The high temperatures and pressures result in the chemical excitation of any matter within or very near the bubbles as they rapidly implode. These bubbles can have temperatures around 5,000K, pressures of roughly 1,000 atm and heating and cooling rates above 1,010K/s.

Ultrasonication is also a reliable tool for sample preparation in a lab. A typical frequency used for this application is about 200 kHz. Usual applications of ultrasonication include homogenization, emulsification, dispersion, extraction, degassing, and sono-chemical treatments.

The wide-spread use of ultrasonication has led to the need in the art for a method of testing or monitoring the efficiency of ultrasonic cleaning to insure adequate time and energy is imparted in the sample while avoiding excessive treatment. There have been many efforts to provide a method, or a system, which can monitor the effect of ultrasonication.

One known method of testing and monitoring the efficiency of ultrasonic cleaning involves the immersion of a thin, conventional aluminum foil into a water basin. Upon ultrasonication small holes are created in the foil by the cavitation bubbles wherein the number of holes in the foil are representative of the length of time used for the cleaning with ultrasonication. The disadvantage of this method is that it does not provide an objective and reproducible test parameter and it is therefore difficult for the user to reliably judge the efficiency of the ultrasonic device.

A device and method that enables testing of the cleaning efficiency of an ultrasonic cleaning device is disclosed in U.S. Pat. No. 7,708,836. The testing device comprised a vessel containing at least one fluid that undergoes a visibly discernable change in color or color intensity upon exposure to collapsing cavitation bubbles produced by the movement of ultrasonic waves generated by the ultrasonic cleaning device. A wall of the vessel is constructed to include at least a portion that is transparent. The vessel further comprises a cavitation promoter comprising glass beads or quartz sand. The vessel may optionally contain a second fluid, which is preferably a gas bubble, which may comprise, for example, atmospheric air or a halogen gas, for example, Cl₂, Br₂ or I₂ gas. A method utilizing the devices might comprise an aqueous sodium chloride solution, and the second fluid might comprise a gas bubble of atmospheric air, whereby the chlorine in the aqueous NaCl solution would ultimately be oxidized. The first fluid might then further comprise an analytical agent capable of analyzing the intensity of the color of the oxidized chlorine. The fluid comprises aqueous red phosphorus or phosphite, a methanol solution, a redox system solution, a halogenide ion solution, a halo-organic compound solution, an oxidative or reductive solution forming or decolorizing a colorant, and a solution polymerizing an organic monomer. The device based on U.S. Pat. No. 7,708,836 is available commercially for example as Sonocheck® from Healthmark Industries Company, Inc., Fraser, MI (USA).

Wash indicators based primarily on dissolution or dispersion of a dye/pigment from a coating on a substrate are also used for monitoring ultrasonic cleaning. Indicators of this type are available commercially from gke GmbH, Waldems-Esch, Germany; Propper Manufacturing Company, Inc., Long Island City, NY (USA) and Steris, Mentor, OH (USA). These indicators are wash indicators and are not selective to ultrasonic. Examples of such non-ultrasonic wash/cleaning indicators are given in U.S. Pat. Nos. 8,343,437; 4,129,954; U.S. Published Application No. 20150233848A1; and EP1769808A2.

In spite of the extensive effort there is still a need for an indicator which monitors the length of time, temperature and energy imparted by ultrasonic cleaning. Such an indictor or monitor is provided herein.

### SUMMARY OF THE INVENTION

It is an object of the instant invention to provide chemical indicators for monitoring ultrasonic cleaning based on the formation of an opaque emulsion, preferably without a surfactant or with a very low concentration of a surfactant, which changes from a clear mixture to an opaque mixture upon ultrasonication wherein the chemical indicator comprises water, an oil and an emulsion-aid.

It is another object of the instant invention is to provide chemical indicators for monitoring ultrasonic cleaning based on a color change of a formulation comprising a liquid medium, preferably water, a dye and a nitro-compound and/or halogen compound.

Yet another object of the present invention is to provide a chemical indicator for monitoring ultrasonic cleaning based on the formation of a colored emulsion upon ultrasonication.

Yet another object of the instant invention is to provide chemical indicators for monitoring ultrasonic cleaning based on dissolution or dispersion of a mixture comprising a solid in a solvent, preferably water, wherein the dissolution or dispersion of the solid results in a change in opacity and/or color.

Yet another object of the instant invention is to provide a cavitation promotor or an agitation aid for an ultrasonic indicator mixture.

Yet another object of the instant invention is to provide chemical indicators for monitoring ultrasonic cleaning based on dissolution or dispersion of a mixture composed of a solid in water.

Yet another object of the instant invention is to provide chemical indicators for monitoring ultrasonic cleaning based on breaking of microcapsules.

Yet another object of the instant invention is to provide a closed, or sealed, glass or plastic clear container containing the ultrasonic indicator mixtures.

Yet another object of the present invention is to provide devices which are machine readable by printing or attaching a readable indicia such as a barcode, quick-response (QR) code or color reference bar on the container of the ultrasonic indicator.

Yet another object of the present invention is to provide a color reference chart for monitoring full or partial doneness of the sonication process.

Yet another object of the instant invention is to monitor the cleaning of an object by ultrasonication by monitoring a color change, change in opacity, change in opacity or changing the readability of a barcode printed on the device.

These and other advantages, as will be realized, are provided in an ultrasonic indicating device. The device comprises a container comprising a solvent and at least one composition selected from the group consisting of:
water, a water insoluble organic liquid as an emulsion aid and an oil; and optionally,
a pH indicator and at least one of a nitro compound or a halo compound.

Yet another embodiment is provided in a method of monitoring ultrasonic cleaning comprising:
placing an ultrasonic indicating device in an ultrasonic cleaning device comprising a fluid and an object to be ultrasonically cleaned wherein the ultrasonic indicating device comprises a container comprising water and at least one composition selected from the group consisting of:
a water insoluble organic liquid as an emulsion aid and an oil; and optionally,
a pH indicator and at least one of a nitro compound or a halo compound;
applying ultrasonic radiation to said fluid until the composition changes in at least one of color or opacity.

### BRIEF DESCRIPTION OF DRAWINGS

FIG. 1 is a schematic representation of a color changing ultrasonic indicator (USI) device before (A) and after (B) ultrasonication.

FIG. 2 is a schematic representation of an emulsion forming USI device before (A) and after (B) ultrasonication.

FIG. 3 is a schematic representation of an emulsion forming USI device with a barcode before (A) and after (B) ultrasonication.

FIG. 4 is a schematic representation of color changing and emulsion forming sealed ampule USI devices before (A & C, respectively) and after (B & D, respectively) ultrasonication.

FIG. 5 is schematic presentation of blister USI before (A) and after (B) sonication.

FIG. 6 is a schematic representation of a centrifuge tube having a sticker adhered outside the plastic centrifuge tube before (A) and after (B) sonication of Example 39. The sticker could be of any color, message or a barcode.

### DESCRIPTION

The present invention is directed to ultrasonic indicators (USI) capable of indicating if an object to be cleaned has been subjected to sufficient time and energy during ultrasonication. More specifically, the present invention is directed to ultrasonic indicators which are based on (i) the formation of a white/opaque emulsion from a clear/transparent mixture of an oil, such as a vegetable oil such as castor oil, and/or an organic liquid, such as diethyl phthalate as an emulsion aid and water without or a low concentration of a surfactant which undergoes change in opacity, (ii) a mixture of a dye, such as a pH dye, a nitro-compound, such as 1,8-dinitronaphthalene in water which undergoes a color change upon ultrasonication and (iii) mixture of water, an oil, such as a vegetable oil such as castor oil, and/or an organic liquid, such as diethyl phthalate as an emulsion aid and without or a low concentration of a surfactant, and a dye, such as a pH dye and a nitro-compound, such as 1,8-dinitronaphthalene in water which undergoes a change in opacity and a color change upon ultrasonication. A particular feature is the ability to provide a device which has a barcode which is readable by a human or machine indicating sufficient ultrasonication. For a given frequency and intensity of the ultrasonic radiation, formation of the emulsion and the color change depend upon time and temperature, thereby making it possible to monitor cleaning of an object upon ultrasonication.

The instant invention provides chemical indicators for monitoring ultrasonic cleaning based on the formation of an opaque emulsion, preferably without or a low concentration of a surfactant, wherein the emulsion changes from a clear mixture comprising water, an oil and/or a non-oil organic liquid as an emulsion aid upon ultrasonication.

For the purposes of the instant invention an emulsion aid is a water-insoluble, non-oil, non-surfactant organic or inorganic compound which helps in emulsifying an oil and water upon ultrasonification.

In the instant application sonification is synonymous with ultrasonication or treatment with ultrasonic energy in an ultrasonic device such as an ultrasonication bath

The USI system offers many advantages. The system is an essentially non-toxic and environmentally friendly system. The materials used are preferably non-hazardous, liquids which are high boiling and have no bad odor. Inexpensive materials are used to make the devices. Plastic and glass containers and blister packs can be used. Any sized/shaped plastic and glass containers can be used. Plastic containers can be sealed by ultrasonic welding or heat. The medium is preferably of low viscosity. The emulsion system is a primary or direct reaction system. The devices are easy to manufacture. The devices are human and machine/barcode readable. The devices can be made to float on the surface and hence are easy to place and retrieve. They can be used on dirty cleaning baths. For cleaning of medical devices, nothing is added in the bath, this device is ideal and can be used along with the medical devices. The devices are not position or location sensitive. Agitation aids, such as glass beads, are optional. Very wide options of oils and an emulsion aid, plasticizers, dyes, and additives can be used to make the devices. The devices are unaffected by ambient conditions or shaking/vibrations during transportation. It is possible to vary the time and temperature requirements by varying the nature and concentrations of the ingredients. The devices can be color changing, emulsion forming, emulsion and color changing and/or machine/barcode readable.

The invention will be described with reference to the figures which are integral, but non-limiting, part of the specification provided for clarity of the invention. Throughout the various figures similar elements will be numbered according.

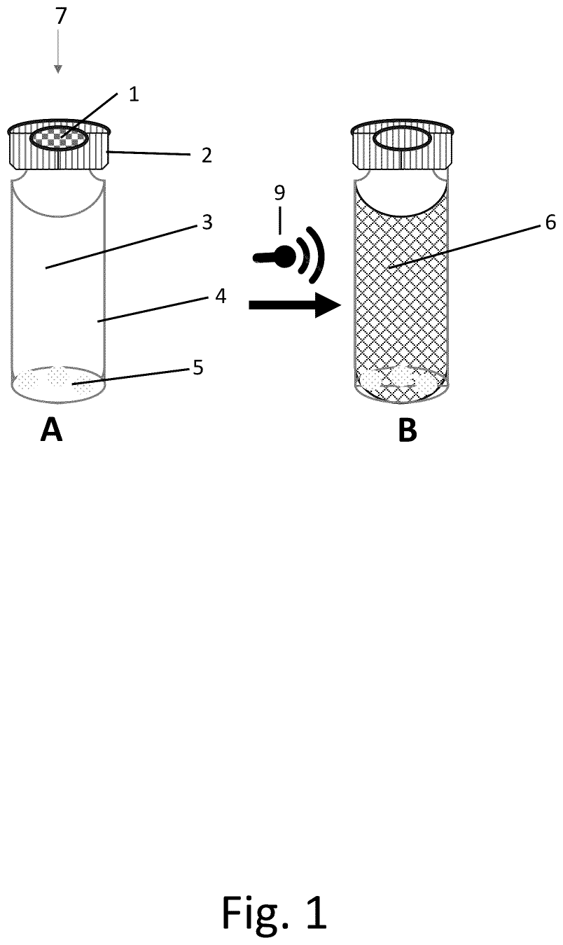

An embodiment of the invention will be described with reference to FIG. 1 wherein a USI device, 7 is illustrated schematically. In FIG. 1A a container, 4, contains the indicating formulation, 3. The container can be a glass or plastic vial which is preferably transparent clear or colorless fitted with a rubber septum, 1, and aluminum crimp seal cap, 2. Agitation aids, 5, are preferably in the container. The ultrasonic sensitive formulation can undergo a color change upon agitation by ultrasonication, 9, resulting in a sonicated indicating formulation, 6, as indicated in FIG. 1B.

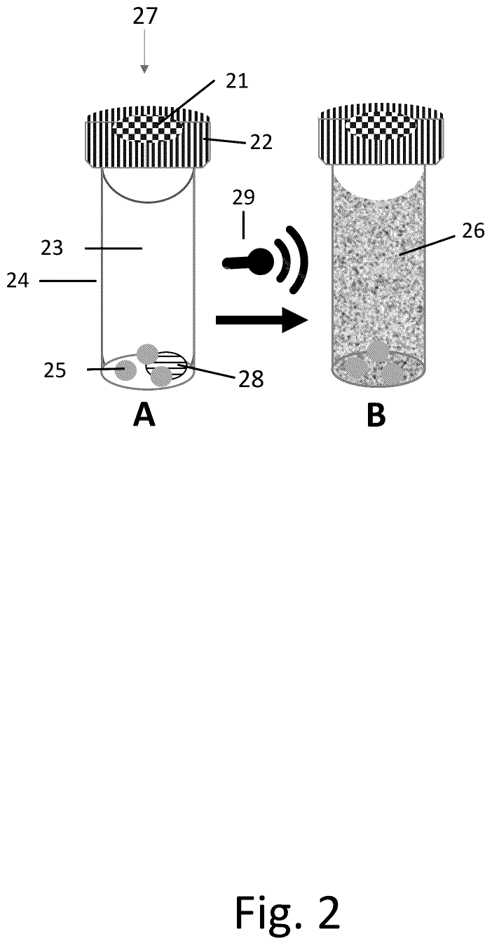

FIG. 2 schematically represents a USI device, 27 which changes in opacity. In FIG. 2A a septum, 21, is secured by an aluminum crimp sealed cap or a screw cap, 22, sealing an indicating formulation, 23, in the container, 24. Agitation aids, 25, assist in sonication. Oil, 28, is dispersed after sonication, 29, resulting in an opaque white emulsion, 26, after ultrasonication, FIG. 2B.

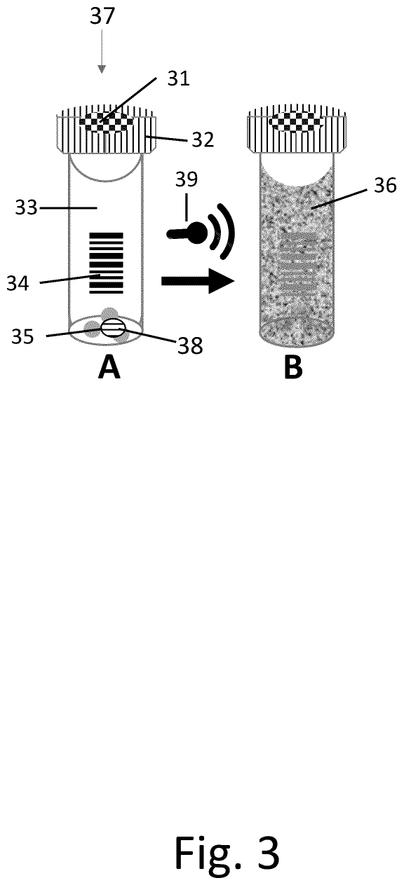

FIG. 3 schematically represent a barcode readable USI device 37. In FIG. 3A a rubber septum, 31, secured by an aluminum crimp sealed cap or a screw cap, 32, seals a clear indicating formulation, 33, in the container. Prior to ultrasonication a barcode 34 on a white substrate on the container is visible through the transparent emulsion. During sonication, 39, the agitation aids, 35, and oil, 38, form an opaque white emulsion, 36, thereby rendering the barcode unreadable, FIG. 3B.

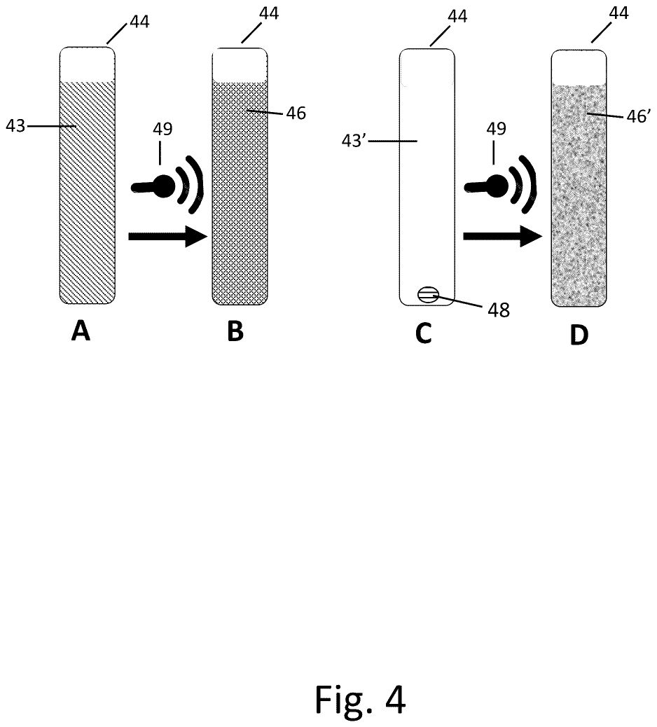

In FIG. 4 the container for the USI device can be a sealed glass or plastic capsule, 44, as illustrated schematically in FIG. 4. In FIG. 4A, prior to sonication, 49 the emulsion is one color, represented by 43, and another color, represented by 46 in FIG. 4B, after sonication. Alternatively, the emulsion is transparent prior to sonication comprising an oil, 48, represented by 43′ in FIG. 4C, and opaque after sonication represented by 46′ in FIG. 4D.

A typical USI device has an indicating formulation inside a glass container with a crimped aluminum cap. The device can optionally have an agitation aid, such as glass beads to accelerate the reaction and stirring/mixing the formulation. The formulation can undergo a color change, such as green-to-red or an emulsion formation upon ultrasonication.

A proper formulation in the USI device can form an emulsion upon ultrasonication. A mixture of water, oil and an organic solvent will be clear before ultrasonication and will emulsify to a stable white, opaque emulsion after ultrasonication. The device can have a barcode.

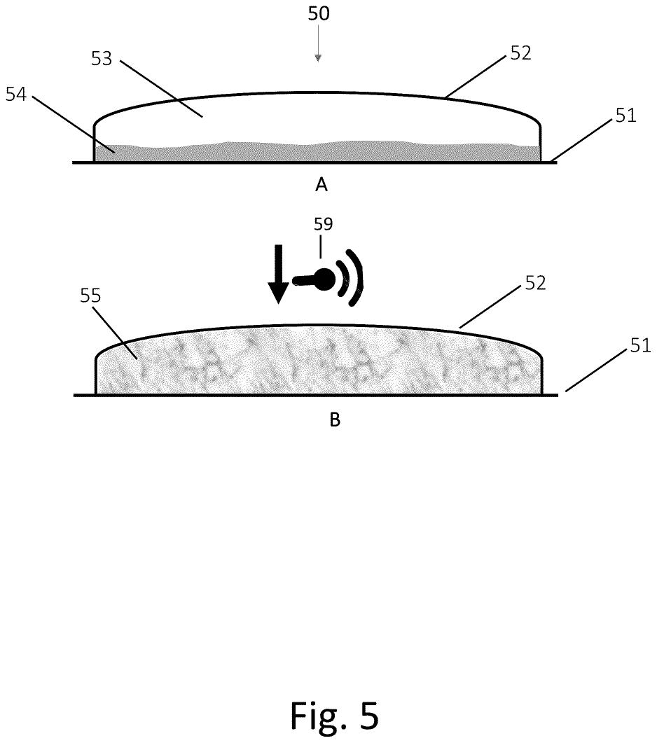

An embodiment is illustrated schematically in FIG. 5, such as a blister device 50. In FIG. 5 an opaque substrate, 51, has a blister transparent film, 52, thereon. The solvent, 53, which is preferably water, and water insoluble liquids, 54, are separated prior to sonication, 59 in FIG. 5A. After sonication the emulsified water and water insoluble liquid are opaque as represented by 55 in FIG. 5B.

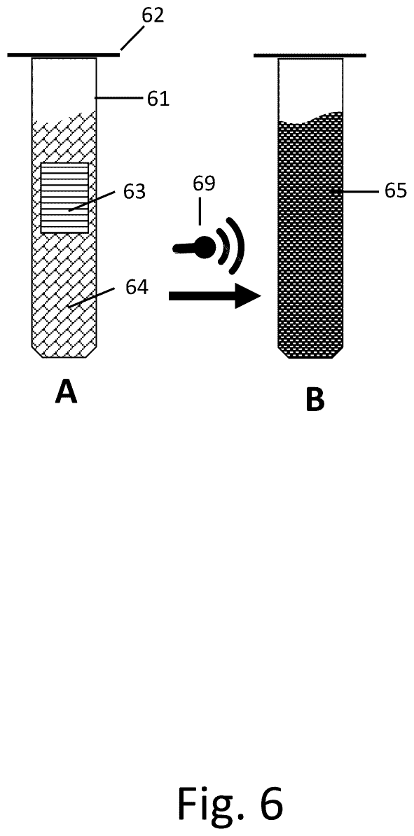

FIG. 6 shows a centrifuge tube, 61, closed with a cap 62, having printed a, preferably blue, sticker 63, adhered outside back of the plastic centrifuge tube before (A) and after (B) sonication, 69. The sticker could be of any color, message or a barcode. The formulation 64, becomes white opaque 65, due to emulsion formulation upon sonication and the sticker becomes invisible.

A USI device preferably comprises a closed glass or plastic transparent or translucent container containing an ultrasonic sensitive formulation. The preferred shape of the container is cylindrical but can be of other shapes. The size of the container can vary from 0.5 ml to about 25 ml, preferably 1-3 ml. It can be from 0.2 cm to 10 cm long or 0.2 to 5 cm in diameter. After filling the container with an ultrasonic formulation, and optionally a few glass beads as agitation aids, it must be tightly sealed to prevent leaking of the liquids. The mouth of the container can be closed with a rubber septum and crimp sealed with an aluminum cap or with a self-locking plastic screw cap. The container can be heat sealed instead of sealed by a cap. The container can have a color label, a label with a barcode and/or a color reference chart.

The plastic container can be made of polyethylene, propylene, polystyrene, polyacrylics such as polymethylmethacrylate, polyester, nylon, polyvinyl such as polyvinyl chloride and their copolymer.

A USI device with a barcode printed on the container, or a clear adhesive label printed with a barcode applied on the container, is preferable. The formulation can be a clear solution before ultrasonication and change to a white opaque emulsion after ultrasonication or vice versa. The barcode will be readable when clear and will not be readable when opaque.

The USI device can be a sealed glass or plastic ampule with the ultrasonication formulation inside the ampule. Depending upon the composition of the indicating formulation, it can undergo a color change or can undergo formation of a white or opaque emulsion upon ultrasonication.

The amount of oil is typically about 0.01 g-0.5 g, per about 2 ml of distilled water in an emulsion forming USI device. Particularly preferred oils are almond oil, avocado oil, black cumin seed oil, canola oil, coconut oil, refined castor oil, corn oil, flax seed oil, jojoba oil, mineral oil, extra virgin olive oil, rosehip oil, safflower oil, sesame oil, cottonseed oil, palm oil, peanut oil, rapeseed oil, soybean oil, sunflower oil, beech nut oil, Brazil nut oil, cashew oil, hazelnut oil, macadamia oil, mongongo nut oil, pecan oil, pine nut oil, pistachio oil, walnut oil, pumpkin seed oil, açaí oil, blackcurrant seed oil, borage seed oil, evening primrose oil, amaranth oil, apricot oil, apple seed oil, babassu oil, ben oil, Borneo tallow nut oil, cape chestnut oil, carob pod oil, cocoa butter, cocklebur oil, and cohune oil. Particularly preferred oils are triglycerides which can be either synthetic or natural. Synthetic oils such as paraffin and silicone oils can also be employed.

Vegetable oils and organic liquids which are insoluble in water, form a separate phase in water in containers of the USI devices. Upon sonication the vegetable oils and organic liquids emulsify but require shaking the container to form uniform emulsion. The addition of water-soluble compounds, especially water-soluble organic liquids such as ethanol, isopropanol and glycerin minimize or eliminate the shaking of the container after the sonication to get uniform emulsion. The shaking of the USI device is also minimized by adjusting the density of water to that of oil or water-insoluble organic liquid. The density of water can be increased by adding water-soluble compounds having density higher than water and vice versa.

Oils/triglycerides and many organic liquids such as toluene are not miscible/soluble in water. However, an oil can be emulsified if sufficient amount of a surfactant is added in the mixture of oil and water, and shaken vigorously. Emulsification of oils and organic solvents with ultrasonic radiation is known but it still requires sufficient amount of a surfactant and vigorous shaking/stirring to make an emulsion. Oil and water cannot be emulsified, and water and many organic solvents cannot be emulsified to a stable emulsion without sufficient quantity of a surfactant even upon ultrasonication. A surfactant cannot be added in the mixture of water and oil to make the USI devices because the mixture may form an emulsion during normal handling and shipment or such devices can be tampered with.

Some soft solids can be either dissolved or dispersed in a liquid medium, such as water and/or organic solvents, upon ultrasonication. Such dispersions or dissolution of soft solids upon ultrasonication will be associated with a change in opacity. An important advance is the development of USI devices which are based on dispersion and/or dissolution of soft solids. Most water-insoluble inorganic compounds, such as minerals, are hard and most of the organic solids are usually soft. For example, when fine particles of naphthol AS in water are sonicated, they form a stable white emulsion/dispersion. Similarly, many dyes and pigments form color solutions or dispersions upon ultrasonication.

A solvent, or an organic water-insoluble liquid can be used as an emulsion aid. Particularly preferred non-oil organic liquids as emulsion aids can be selected from substituted or unsubstituted aliphatic or aromatic amides preferably acetamide, dimethylformamide and chloroacetamide; alcohols, preferably amyl alcohol, hexyl alcohol, and dichloropropanol; esters, preferably methylpropionate, amylformate, diethyl maleate, ethylene glycol diacetate, ethylsalicylate, and triacetin; nitroalkanes preferably nitropropane; aldehydes, preferably butyraldehyde; carbonates, preferably diethylcarbonate and propylene carbonate; aromatic alcohols/phenols, preferably dihydroxy benzene, benzyl alcohol and phenol; amines, preferably diethanolamine, dimethylpyridine and cyclohexane diamine; ether-esters preferably ethoxyethylacetate, trioxane, tetraethylene glycol dimethylether, benzyl ether, phenylether, propylene glycol ethylether acetate and propylene glycol butylether; alcohol-esters, preferably ethylene glycol monoacetate; acids, preferably glutaric acid, isobutyric acid, mandelic acid, and toluene sulfonic acid; ketones, preferably methylethylketone, hydroxyacetophenone, ketone-esters, preferably methylacetoacetate; lactones, preferably propiolactone and butyrolactone and methylpyrrolidone or mixture thereof.

Particularly preferred non-oil organic liquids as emulsion aids include: benzyl ether, 4-(benzyloxy)phenol, bis (2-ethylhexyl) adipate, bis (2-ethylhexyl) sebacate, cyclopentanone, dibutyl adipate, dibutyl diacetate, diethyl malate, diethyl malonate, diethyl oxalate, diethyl phthalate, diethyl succinate, diethyl l-tartrate, dimethyl carbonate, dimethyl maleate, dimethyl malonate, dimethyl phthalate, dioctyl phthalate, ethylene carbonate, ethylene glycol diacetate, candelilia wax, bees wax, paraffin wax, paraffin wax, benzyl n-butyl phthalate, dibutyl phthalate, triethyl phosphate, triphenyl phosphate, tris (2-butoxy ethanol) phosphate, tris (2-chloroethyl) phosphate, diethyl phthalate, acetonitrile, 1-butoxy-2-propanol, 1,4-dioxane, 1,3-dioxolane, ethanol, 2-ethoxyethanol, glycerin, ethylene glycol mono-butyl ether acetate, isopropanol, methanol, 1-methoxy-2-propanol, nitromethane. Though inorganic liquids can be used, preferred are organic solvents. Organic liquids alone do not form stable emulsion without surfactant.

The emulsion aid can be used at a concentration of about 0.01 g-0.5 g per about 2 ml of distilled water.

The instant invention does not require a surfactant and it is preferable to not include a surfactant in the ultrasonication formulations. The present invention is compatible with no surfactants or with a surfactant at low concentration of below 0.1 wt %. A surfactant concentration of 0.001 to 0.1 wt % of surfactant is acceptable in some embodiments. Surfactants can be used to stabilize the emulsion formed upon ultrasonication and the low concentration neither makes the mixture turbid or emulsify to a stable emulsion upon shaking. Particularly suitable surfactants for demonstrating the invention include Brij 72, Igepal co-990, pluronic F68, ammonium laurate, calcium oleate, polyethylene oxide with 7-8 repeat units, tert-octylphenol, sodium oleate, tin oleate, zinc oleate and Rhodafac RS710.

Agitation aids function as cavitation promotors which can expedite the color change and emulsion formation during ultrasonication. Agitation aids also help in mixing the formulation of USI during sonication. Representative agitation aids, without limit thereto include: Timeset™ 304 stainless steel woven wire 200 mesh screen; Red Devil™'s 0 fine steel wool pad, 00 very fine steel wool pad, and 000 extra fine steel wool pad; stainless steel scrubbing scouring pad sponge, Sophisti™ clean stainless steel microfiber cloth; crafts black beads; crafts silver beads, Darice™ no hole beads; Pandahall™ beads; zirconium beads; glass beads; alumina beads; q-bead glass 1.2 mm beads; q-bead glass 3 mm beads; washed sand; white quartz powder; German glass glitter; hollow cylinder glass pieces; WGV™ white coarse sand; silica gel 70-230 mesh 60 Angstroms; white quartz sand; Balabead™ glass seed beads beige 0.6 mm; transparent 2 mm and pearlized white 2 mm beads; Czech bugle beads 7 mm; Estes™ gravel products aes06606; marine sand black; Podzly™ white decorative bulk craft sand; glass q-beads 0.8 mm; royal ram natural white marble decorative real sand; rock shed tin oxide polish; and Quackenbush™ zirconium silicate 1.0 mm. The agitation aid can be hollow such as hollow glass beads.

A material which is sensitive to ultrasonic radiation and undergoes a physical or chemical change is referred to herein as an activator. For example, halocarbon compounds such as chloroform undergo degradation and produce hydrochloric acid upon ultrasonication. Similarly, nitro-compounds such as 1,8-dinitronaphthalene can undergo degradation and produce nitric acid upon ultrasonication. Thus, halo-compounds and nitro-compounds are activators. When the acids produced upon the ultrasonication react with a pH dye dissolved or dispersed in water, it changes the color of the pH dye. The pH dye is an indicator. An oil, such as castor oil, can be emulsified to a stable emulsion upon ultrasonication when aided with a solvent, such as benzyl ether. Thus, halo-compounds, nitro-compounds and oil are activators for the USI device. Instead of an oil, one can use water-insoluble organic liquid such as benzyl ether as activator. Water is a medium. When an oil is emulsified upon ultrasonic radiation, it forms an opaque white emulsion. Though a dye can be added but no dye is required to see the emulsion. Thus, an oil or a water-insoluble organic liquid before the ultrasonication is an activator and once it is emulsified, the emulsion is an indicator.

Halo-compounds, including inorganic halo-compounds, can be used as an activator to produce hydrochloric acid upon ultrasonication. The preferred halo-compounds as activators are halo-hydrocarbons. Particularly preferred halo-compounds that can be used as activators to make color changing USI devices include: 1-chloro-1-nitropropane, chloroform, carbon tetrachloride, chloroacetic acid, chloropropionic acid, ethyl trichloroacetate, heptachloropropane, hexachlorocyclohexane, methyl trichloroacetimidate, pentachloroethane, tetrachloroethane, trichloroethanol, trichloromethyl benzyl acetate, trichloromethyl propanol hydrate, trichloropropane, trichloroacetamide, trichloroacetic acid, trichloroethaneisocyante, trichloromethylbenzylacetate, trichloromethylpropanol, trichloropropane, chlorinated paraffins, halo polymers, such as polyvinyl chloride, polyvinylidene chloride, polyepichlorhydrin and halogenated polymers, such as chlorinated polyisoprene and chlorinated polyvinylchloride. Other halo compounds include, 1,1-bis [p-chlorophenyl]-2,2,2-trichloroethane; 1,1-bis [p-methoxyphenyl]-2,2,2-trichloroethane; 1,2,5,6,9,10-hexabromo cyclododecane; 1,10-dibromodecane; 1,1-bis [p-chlorophenyl]-2,2-dichloroethane: 4,4′-dichloro-2-(trichloromethyl) benzhydrol; hexachlorodimethyl sulfone; 2-chloro-6(trichloromethyl) pyridine; 0,0-diethyl-0-(3,5,6-trichloro-2-pyridyl) phosphorothionate; 1,2,3,4,5,6-hexachloro cyclohexane; N(1,1-bis [p-chlorophenyl]-2,2,2-trichloroethyl) acetamide; tris [2,3-dibromopropyl]isocyanurate; 2,2-bis [p-chlorophenyl]-1,1-dichloroethylene; tris [trichloromethyl]s-triazine; and their isomers, analogs, homologs. Particularly preferred halocarbons are chloroform, dichloroethane, ethyl trichloroacetate, hexachloroacetone, trichloroaetamide, 1,1,1-trichloroethane, trichloromethylphenyl carbinyl acetate, and tris(2-chloroethyl)phosphate.

Nitro-compounds which can produce nitric acid upon ultrasonication, such as nitroalkanes and cellulose nitrate can be used as an activator to make color changing USI devices. Nitro-compounds that can be used as activators to make USI devices include substituted and unsubstituted aliphatic, aromatic and cyclic nitro-compounds such as nitrophenols, nitrotoluenes, nitronaphthalenes, nitroanisidines, nitrobenzenes, chloronitrobenzenes, amyl nitrite, chloronitropropane, diethylene glycol nitrates, ethylene glycol nitrates, ethyl nitrate, nitroglycerins, nitroso-compounds and nitrocellulose. Other nitro-compounds that can be used to make USI are, inorganic nitrates; such as sodium and ammonium nitrate; and inorganic nitrite, such as sodium nitrite. Particularly preferred nitro-compounds for demonstration of the invention include 2,2′-azodiisobutyronitrile, 3,5-dinitrobenzoic acid, dinitronaphthalene, 1,8-dinitronaphthalene, 3,5-dinitrobenzoic acid, 2,4-dinitro-1-naphthol, disodium 1-nitroso-2-naphthol-3,6-disulfonate, 4-hydroxy-3-nitroso-1-naphthalene sulfonic Acid, 4-nitrobenzoic acid, 5-nitroguaiacol, 4-nitrophenol, 4-nitrosophenol, sodium salt, 1-nitroso-2-naphthol, 2-nitroso-1-naphthol, 4-nitrosophenol, 4-nitrotoluene, ammonium nitrate, sodium nitrate and sodium nitrite.

In an alternate embodiment, the halo compounds or nitro compounds can form a complex with the indicator dye. A complex can undergo a decomplexation or halo compounds and nitro compounds undergo complex formation upon ultrasonication. The complex formation is not limited to halo-compounds or nitro-compounds.

A small amount of inorganic compounds, such as up to 5 wt %, as an adjuvant or as an activator can facilitate ultrasonication of the USI devices. Particularly preferred inorganic compounds include: ammonium acetate, ammonium bromide, ammonium carbamate, ammonium carbonate, ammonium chloride, ammonium dihydrogen phosphate, ammonium ferrocyanide (ii) hydrate, ammonium iron (IIII) citrate, ammonium iron (III) oxylate hydrate, ammonium iron (III) sulfate dodecahydrate, ammonium iron (III) sulfate hexahydrate, ammonium sulfate, ammonium sulfite monohydrate, ammonium thiocyanate, ammonium thiosulfate, alumina, aluminum acetylacetonate, aluminum ammonium sulfate dodecahydrate, aluminum chloride hexahydrate, aluminum hydroxide, aluminum nitrate nonahydrate, aluminum sulfate hexadecahydrate, aluminum sulfate octadecahydrate, benzeneboronic acid, borane-tert-butylamine, borane dimethylamine, boric acid, boric acid tri-n-butyl ester, calcium acetate monohydrate, calcium acetyl acetonate hydrate, calcium bromide anhydrous, calcium bromide monohydrate, calcium chloride, calcium ferrocyanide, calcium hydroxide, calcium orthophosphate, calcium sulfide, copper, copper (II) acetate monohydrate, copper (II) acetylacetonate hydrate, copper (II) bromide, copper (I) chloride, copper (II) chloride hydrate, copper pyrophosphate, copper (II) sulfate pentahydrate, copper (I) thiocyanate, cupric benzoate, lithium acetylacetonate, lithium tetra-borate, lithium chloride, lithium formate monohydrate, lithium hydroxide monohydrate, ferric acetylacetonate, iron (II) bromide, iron (II) chloride tetrahydrate, iron (III) chloride hexahydrate, ferric ferrocyanide, ferrocene, p-gluconic acid, iron (II) salt dihydrate, ferric salicylate, iron (II) sulfate heptahydrate, iron (iii) sulfate pentahydrate, magnesium acetate tetrahydrate, magnesium chloride hexahydrate, magnesium oxide, magnesium sulfate heptahydrate, nickel, nickel (IIi) bromide, nickel (II) chloride, nickel sulfate, potassium acetate, potassium benzoate, potassium bromide, potassium carbonate, potassium chloride, potassium ferrocyanide (II) trihydrate, potassium ferricyanide, potassium formate, potassium iodide, potassium nitrate, potassium phosphate, dibasic trihydrate, tri-potassium phosphate, potassium pyrophosphate, potassium sodium tartrate tetrahydrate, sodium acetate, sodium acetylacetonate, sodium bromide, sodium carbonate, sodium chloride, sodium cyanate, sodium dihydrogen phosphate, sodium diethyldithiocarbamate trihydrate, sodium fluoroborate, sodium hexametaphosphate, sodium iodide, sodium metasilicate, sodium nitrate, sodium nitrite, sodium oxalate, sodium thiosulfate pentahydrate, sodium phosphate, dibasic, sodium sulfate anhydrous, sodium sulfite anhydrous, sodium tetraborate, sodium thiocyanate, sodium trimetaphosphate, sodium tripolyphosphate, tin (II) bromide, tin (II) 2-ethylhexanoate, zinc acetate dihydrate, zinc acetylacetonate hydrate, zinc bromide, zinc chloride, zinc iodide, zinc sulfate heptahydrate, zinc sulfide, 3-chlorophenylboronic acid.

A small amount of organic compounds, such as less than 5 wt %, as an adjuvant or as an activator can facilitate ultrasonication of USI devices. Particularly preferred organic compounds include: 4-acetamidophenol, acetone oxime, 2-amino-p-cresol, 4-tert-amylphenol, ascorbic acid, azodicarbonamide, benzilic acid, 2-(2h-benzotriazol-2-yl)-6-dodecyl-4-methylphenol, benzotriazole, benzenesulfonic acid, benzyl sulfoxide, 2-benzoylbenzoic acid, 4,4-bis (4-hydroxyphenyl)-valeric acid, tert-butylhydroquinone, caffeine, trans-cinnamic acid, 2,6-di-tert-butyl-4-methylphenol, 2,7-dihydroxynaphthalene, 4,5-dihydroxy-2,7-naphthalenedisulfonic acid, 4,5-dihydroxy-2,7-naphthalenedisulfonic acid disodium salt, 6,7-dihydroxy-2-naphthalenesulfonic acid, sodium salt hemihydrate, dimethylglyoxime, diphenylamine, 4-diazodiphenylamine sulfate, diazoaminobenzene, dinitronaphthalene, 1,8-dinitronaphthalene, 2,4-dinitrodiphenylamine, ethylenediaminetetraacetic acid, ethylenediaminetetraacetic acid iron (iii) sodium salt hydrate, ethyl gallate, gallic acid monohydrate, gallic acid stearyl ester, gluconic acid, sodium salt 97% (sodium gluconate), 6-gluconolactone, glycerophosphate (calcium salt), 2-hydroxycinnamic acid, 4-hydroxycoumarin, 2-hydroxy-4-methoxybenzophenone7-hydroxy-4-methyl coumarin, 2-hydroxy-1,4-naphthalene, hydroquinonesulfonic acid potassium salt, lauryl gallate, dl-malic acid, mandelic acid, methylhydroquinone, methyl 3,4,5-trihydroxy-benzoate, 5-nitroguaiacol, octadecylamine, 1,10 phenanthroline, phenothiazine, phenylboronic acid, n-phenyl-2-naphthylamine, 4-phenylphenol, phytic acid 50 wt % solution in water, poly (ethylene glycol) dimethyl ether mn˜500, propyl gallate, pyrogallic acid, salicylic acid, salicylamide, salicylaldoxime, tetrabutyl ammonium hydrogen sulfate, tetrabutylphosphonium bromide, tannoform, tetra-n-hexylammoinium bromide, tetrahexylammonium bromide, p-toluenesulfonic acid monohydrate, trichloroacetamide, trimethylhydroquinone, 2,3,4-trihydroxybenzophenone, trichloromethylphenyl carbinyl acetate, triethanolamine borate, 2,2′,4,4′-tetrahydroxy-benzophenone, tris (hydroxymethyl) aminomethane, 1,1,1-tris(4-hydroxy-phenyl)ethane, resorcinol, rutin hydrate, trans-stilbene, urea, glyoxal trimeric dihydrate, 2-diazo-1-naphthol-5-sulfonic acid sodium salt monohydrate, 1-diazo-2-naphthol-4-sulfonic acid, fast blue base B, fast orange base GC, fast red base B, fast scarlet base G, 4-hydroxy-3-nitrobenzoic acid, 4-nitrocinnamic acid, 2′2-biphenol, citric acid, 1,12-diaminododecane, 4-diazo-3-methoxydiphenylamine sulfate, 4,5-dihydroxy-1,3-benzene disulfonic acid disodium salt hemihydrate, 1,6-dihydroxy naphthalene, 3,6-dihydroxy naphthalene-2,7-disulfonic acid disodium salt, ethylenediaminetetraacetic acid tetrasodium salt dihydrate, magnesium stearate, 4-4′oxydibenzenesulfonyl hydrazide, tetrabutylammonium bromide, 2-acetylphenothiazine, ascorbic acid 6-palmitate, benzamide.

Organic halo and nitro compounds undergoing degradation upon ultrasonication to produce an acid which can be monitored by the inclusion of a pH dye which changes color at a particular pH or within a range of pH. Preferred pH dyes include: Acid alizarin violet N, acid blue 89, acid blue 92, acid fuchsin, acridine, alizarin red, alizarin red S, alizarin yellow GG, alizarin yellow R, alkali blue, 9-amino-6-chloro-2-methoxyacridine, 5-aminosalicylic acid, anilinesulfonephthalein, anthranilic acid, aurin, benzaurin, benzopurpurin 4B, brilliant green, brilliant yellow, bromochlorophenol blue, bromochlorophenol blue-sodium salt, bromocresol green, bromocresol green sodium salt, bromocresol purple, bromocresol purple sodium salt, bromophenol blue, bromophenol blue sodium salt, bromophenol red, bromothymol blue, bromothymol blue sodium salt, bromoxylenol blue, calcein, calmagite, carbazol yellow, 5-carboxyfluorescein, 6-carboxyfluorescein, 5-carboxyfluorescein diacetate, 6-carboxyfluorescein diacetate, 5(6)-carboxyfluorescein diacetate succinimidyl ester, 5-carboxynaphthofluorescein, 6-carboxynaphthofluorescein, 5-carboxynaphthofluorescein diacetate, carboxy snafl 1, carboxy snafl 2, carvacrolphthalein, chlorophenol red, chlorophenol red-sodium salt, chrome orange GR, chrysoidin, clayton yellow, Congo red, coumarin, o-cresolbenzein, o-cresolphthalein, o-cresolphthalein complexon, m-cresol purple, m-cresol purple-sodium salt, o-cresol red, o-cresol red-sodium salt, crystal violet, curcumin, dichlorofluorescein, 6,7-dihydroxycoumarin, 3,6-dihydroxyphthalimide, 4-dimethylamino-2-methylazobenzene, dinitrocresol, alpha-dinitrophenol, beta-dinitrophenol, gamma-dinitrophenol, epsilon-dinitrophenol, delta-dinitrophenol, 2,4-dinitrophenylhydrazine, dinitrothymol, direct blue 72, dixylenolphthalein, eosin Y, erythrosin B, esculetin, ethyl-bis(2,4-dinitrophenyl)-acetate, ethyl green, ethyl orange, ethyl red, ethyl violet, fluorescein, fluorescein diacetate, fluorescein disodium salt, fluorescein-5-isothiocyanate, fluorexon, gallein, gentian violet, gentian violet B, guaiacolphthalein, harmine, hematoxylin, 4-heptadecyl-7-hydroxycoumarin, heptamethoxy red, hexamethoxy red, o-hydroxypheylbenzimidazole, o-hydroxypheylbenzothiazole, o-hydroxypheylbenzoxazole, indigo carmine, indophenol, iodophenol blue, isonitrosothiocamphor, isopicramic acid, lacmoid, lanacyl violet BF, luminol, lysosensor blue DND 167, lysosensor blue DND 192, lysosensor green DND 189, lysosensor yellow/blue DND 160, magdala red, malachite green, martius yellow, mesalamine, Metanil yellow, 2-methoxybenzaldehyde, 4-methylesculetin, methyl green, methyl orange, methyl purple, methyl red, methyl red sodium salt, 4-methylumbelliferone, methyl violet, methyl yellow, alpha-naphthoic acid, beta-naphthol, naphthol AS, alpha-naphtholbenzein, alpha-naphtholphthalein, alpha-naphthylamine, beta-naphthylamine, alpha-naphthyl red, neutral red, Nile blue, nitramine, nitrazine yellow, p-nitrobenzhydrazide, p-nitrobenzylcyanide, 4-nitrocatechol, o-nitrophenol, m-nitrophenol, p-nitrophenol, orange II, orange III, orange IV, Oregon green 488 carboxylic acid, Oregon green 514 carboxylic acid, Oregon green 488 carboxylic acid diacetate, patent blue V, pentamethoxy red, phenolbenzein, phenolmalein, phenolphthalein, phenolphthalein disodium salt, phenol red, phenol red sodium salt, 4-(phenylazo)-diphenylamine, o-phenylenediamine, p-phenylenediamine, phloxine B, picric acid, pinachrome, poirrier blue, propyl red, pyrogallolphthalein, quinaldine red, quinine, quininic acid, quinoline blue, resazurin, resorcein, resorcinmalein, resorufin, rhodol green, p-rosolic acid, rubrophen, salicyladehyde semicarbazone, salicylic acid, salicyl yellow, solochrome violet RS, sulphan blue, tetrabromophenol blue, tetrabromophenol blue sodium salt, tetrabromophenolphthalein, tetraiodophenolsulfonephthalein, tetryl, thiazol yellow G, thymolbenzein, thymol blue, thymolphthalein, trinitrobenzene, trinitrobenzoic acid, trinitrotoluene, tropaeolin O, tropaeolin OO, tropaeolin OOO, umbelliferone, xylenol blue, xylenol orange and xylenolphthalein.

Particularly preferred pH dyes include: leuco crystal violet, rose Bengal, rose Bengal lactone, methylene violet 3RAX, malachite green carbinol base, xylenol blue, leuco malachite green, pararosaniline base, methyl violet B base, acridine orange base, and leucoquinizarin.

Water-soluble polymers and gums can be added to the emulsion as a thickener or to facilitate sonication. Particularly preferred water-soluble polymers include: alginates; hydroxy alkyl cellulose such as carboxy methyl cellulose; carrageenan, guar gum, gum agar, gum ghatti, gum karaya, gum tragacanth, locust bean gum, pectin, polyacrylamide, polyacrylic acid, polyvinyl alcohol, polyethylene oxide, polyethylene glycols, polyvinylpyrrolidone, starch and its modified forms, tamarind gum, xanthan gum, gelatins, and polyethyleneimine, their copolymers including graft copolymers and their mixtures, can be used as binders.

In order to eliminate a human error, it is still further preferred to make USI devices machine, such as barcode readable. The conventional barcode readers monitor only blue, green and black barcodes. The device can be made barcode readable if it changes from a light color such as colorless, yellow or red, to blue, green or black, or vice versa. It is preferable to make barcode readable USI devices, that change from opaque-to-clear, yellow/red-to-blue, green or black, or vice versa. A change in an opacity and color intensity can be more accurately monitored with a barcode reader than by a human.

Many USI devices based on changes in color and opacity, undergo a series of gradual changes, such as blue→blue-green→green→yellow-green→yellow→red, vice versa and many shades in-between. Alternatively, they change from colorless to a color gradually or from clear to opaque gradually. In order to determine a minimum requirement is met, a color reference chart is preferred wherein the color chart is printed either on the USI device or provided separately so the user can estimate the doneness.

Stabilizers, thickeners, density adjusters, and anti-oxidants can be incorporated into the emulsion forming and color changing formulations.

Particularly preferred thickeners include organic or inorganic, low molecular weight materials. Fumed silica is a suitable thickener. Oligomeric or high molecular weight, typically water-soluble, polymers such as polyethylene oxide and polyethylene glycol are suitable thickeners. Thickeners can be water-soluble or solvent-soluble. Polyvinyl alcohol, partially hydrolyzed polyvinyl acetate is particularly suitable. Thickener function to delay the color change.

The time required for the noticeable change, such as a color change or emulsion formation, can be varied from five seconds to several hours at room temperature by varying the nature and concentrations of the ingredients of the USI formulation. The device can be used over a very wide temperature range, such as from 10° C. to 70° C. The concentrations of the ingredients can be varied from 0.001% to 50% with the balance being water. The device is particularly suitable for use in monitoring sonication with ultrasonic radiation from 20 kHz-200 kHz.

It is preferable that the mixture does not form an emulsion upon normal handling, shaking or vibration during normal handling and transportation/shipment.

It is preferable that the mixture remains unchanged upon freezing or heating under ambient conditions.

A water-insoluble oil composition is a composition which can be a solid, liquid, an organic composition, an inorganic composition, or a biological composition which is substantially insoluble in water. The oil may have slight solubility, usually less than 10 wt % in water. These compositions may also be referred to as an oil, such as a vegetable oil. An oil is not miscible with water. One typically needs to add sufficient quantity of a surfactant to emulsify a mixture of an oil and water. A mixture of water and water-insoluble liquids, such as toluene and decane, can be emulsified by adding sufficient quantity of a surfactant and shaking or stirring the mixture. Without sufficient quantity of a surfactant an oil can't be emulsified even upon ultrasonication. Ultrasonication expedites the making of the emulsions without or with very low concentration of a surfactant.

A water-soluble composition is a composition which can be a solid, liquid, an organic composition; an inorganic composition, or a biological composition which is substantially soluble in water. The water-soluble composition may have limited solubility in water such as more than 20 wt %.

About 8% of men and about 0.5% of women are colorblind. Colorblind people see red color differently. Hence, there is a need to develop USI devices which undergo from a very dark color; such as black, blue, green or purple; to light color; such as colorless, yellow, orange or red; or vice versa. One of the objectives is to develop USI devices which undergo a color change from very light color to very dark color or vice versa, or from clear to opaque.

The USI can be used in any application wherein ultrasonication is to be monitored. Particularly suitable environments include: medical offices, hospitals, surgical facilities, dental offices, machine shops, jewelers, optometry, avionics, engineering, automotive and printing who often clean the parts by ultrasonication.

The following Examples are illustrative of carrying out the invention and should not be construed as being limits on the scope and spirit of the instant invention.

### EXAMPLES

### Example 1: Chloroform Solution

A solution of 10 g chloroform, 10 g ethanol and 2,000 g distilled water was made to use as an activator.

### Example 2: Nitrazine Yellow Solution

A stock solution of nitrazine yellow included 0.50 g nitrazine yellow, 30 g ethanol, 15 g distilled water and 1.70 g NaOH solution (0.25 g sodium hydroxide dissolved in 10 g distilled water) was prepared. A diluted solution containing 10 g of the above nitrazine yellow stock solution and 90 g distilled water was made.

### Example 3: Universal Indicator Solution (UI)

A solution of universal indicator (UI) was prepared by dissolving 0.10 g phenolphthalein, 0.20 g methyl red, 0.30 g methyl orange, 0.40 g bromothymol blue, and 0.50 g thymol blue in a mixture of 50 g ethanol and 50 g distilled water. About 0.25 g sodium hydroxide dissolved in 10 ml distilled water was added dropwise till the above solutions turned light blue. A dilute solution was made by diluting 3 g above concentrated solution with 190 g distilled water and 10 g isopropanol was used as a UI.

### Example 4: Universal Indicator Solution (UI_JPL)

Another solution of universal indicator was made by dissolving 0.36 g phenolphthalein, 0.18 g methyl red, 0.43 g bromothymol blue in a mixture of 55 g ethanol and 30 g distilled water. About 0.25 g of sodium hydroxide dissolved in 10 g distilled water was added dropwise till the solution turned light blue. A dilute solution was made by diluting 3 g of the above concentrated solution in 190 g distilled water and 10 g isopropanol. This universal indicator is referred to UI_JPL.

### Example 5: Ultrasonicators

The following ultrasonicators were used for testing the USI devices: (i) A DK SONIC (made in China) ultrasonic cleaner, model number DK-3000H, 30 Liter capacity, (ii) VEVOR (made in China) ultra cleaner model number JPS-20A, 3.2 liter capacity, (iii) BRANSON (Danbury, CT, USA) Bransonic 1200 ultrasonic cleaner, model #B1 200R-4 and (iv) FISHER (Waltham, MA, USA) Sonic Dismembrator (Model 300).

### Example 6: Shakers

In order to determine vibrational stability of USI devices during shipment, selected USI formulations were shaken on (i) Atomix type 50800 by Thermodyne (Dubuque, Iowa, USA) and/or (ii) Orbital Shaker, CO-Z, (China) from minutes to hours to visually note any change in color or a formation of an emulsion.

### Example 7: Shelf Life and Stability Determination

In order to determine environmental stability of USI formulations during storage and shipment (i.e., shelf-life), selected USI formulations before and after ultrasonication were placed in a freezer (˜minus 10° C.) and also in an oven at ˜50° C. for one or more days. The samples were brought out to see if they did not undergo any color or clarity change or change in emulsion.

### Example 8: Containers Used

A wide variety of containers were used to make USI device samples. To begin, solutions were tested in 15 mm×85 mm glass test tubes. Depending on results, specific solutions were then further tested in different types of containers. The most common used was a glass container with a screw cap. The following plastic containers were also used: 2 ml polypropylene centrifuge tubes with snap caps, 0.2 ml microcentrifuge tube plastic test vials with snap caps, 5 ml plastic graduated vial tube with screw caps, 5 ml plastic test tubes small with lids, and a 2 ml plastic vial tube with lids.

### Example 9: Method of Making Indicator Samples

In a 10 ml test tube, a few particles of a dye along with a few ml of the chloroform solution or nitromethane were added to water and shaken or heated to dissolve. An agitation aid was added to the mixture. The test tube was placed in a rack and then into an ultrasonicator bath. It was ultrasonicated for a varied amount of time from 1-30 minutes. Any color change was noted. Selected solutions were then tried in a glass vial with a screw cap for reproducibility in an ultrasonicator.

### Example 10: Making Mixtures for Emulsion

In a 10 ml test tube a few drops of an oil or organic liquid/solvent and a few glass beads were added to a few ml of distilled water and hand shaken to mix. The test tube was placed in a rack and into an ultrasonicator bath. The sample was ultrasonicated for a varied time up to about 30 minutes. Any emulsion formation was noted. Any change in stability of emulsion was noted after at least a day at room temperature. Selected solutions were then tried in a glass vial with a screw cap for reproducibility. Selected emulsion-forming formulations were shaken on a shaker for transportation stability. They were also tested for environmental stability by keeping them in an oven and a freezer. These tests were done before and after sonication as well.

### Example 11: USI from Microencapsulated Materials

In a 10 ml test tube, a few ml of UI_JPL and a pinch of a washed encapsulated material were added. Encapsulated materials used include: Balchem Bakeshure 201 encapsulated sodium bicarbonate 85%, Balchem Bakeshure 250 encapsulated sorbic acid 70%, Balchem Meatshure 509 encapsulated lactic acid 30%, Maxx microencapsulated sodium diacetate food grade edible wax and Balchem Meatshure 501 encapsulated sodium diacetate 70%. Upon sonication, the UI_JPL changed color from blue/green-to-red.

### Example 12: Inorganic and Organic Materials

In a 10 ml test tube, a pinch of inorganic or organic compounds were added to a solution of water (as a control), UI_JPL (or UI), chloroform or nitromethane solutions. Agitation aids were also used with these materials. The test tube was placed in a rack and then into an ultrasonicator bath. It was ultrasonicated for a varied amount of time up to 30 minutes. Any color change was noted. Selected solutions were then tried in a glass vial with a screw cap for reproducibility in an ultrasonicator.

### Example 13: Emulsions

In a 10 ml test tube, a different amount of an oil, an organic solvent, and a mixture of oil and organic solvent in water and glass beads were placed in a rack and then sonicated. Any emulsion formation was noted. Selected emulsion-forming formulation were then tried in a glass vial with a screw cap and plastic centrifuge tubes for reproducibility in an ultrasonicator. These emulsion experiments also included dyes as well as inorganic and organic compounds to see if a colored solution, dispersion or emulsion would form.

Example numbers 14 and 15: Dispersion of solid upon sonication¹.

| Example | | |
|---|---|---|
| number | Dye | Sonication color change |
| 14 | Fast scarlet R salt | Colorless to dark brown dispersion |
| 15 | Malachite green | Colorless to blue-green opaque |
| | carbinol base | dispersion |

¹Particles of the dyes were sonicated with 1 ml distilled water in a test tube.

1. Particles of the dyes were sonicated with 1 ml distilled water in a test tube.

Example numbers 16 to 23: Color change upon sonication.

| Example | | | | |
|---|---|---|---|---|
| Number | Activator | Container | Particle of indicator/dye | Sonication color change |
| 16 | Chloroform¹ | Glass vial | Leuco crystal violet | Colorless to light blue |
| 17 | Chloroform¹ | Glass vial | Malachite green carbinol base | Colorless to dark blue |
| 18 | Chloroform¹ | Glass vial | Rose Bengal lactone | Pink to colorless |
| 19 | Nitromethane² | Test tube | Indigo | Fine dispersion of the |
| | | | | blue particles |
| 20 | Nitromethane² | Test tube | Diphenylthiocarbazone | Fine dispersion of the |
| | | | | blue particles |
| 21 | Nitromethane² | Test tube | Thymolphthalein | Fine dispersion of the |
| | | | | white particles |
| 22 | Sodiumn bisulfite³ | Test tube | UI_JPL (1 drop)⁴ | Red to yellow |
| 23 | Sodium nitrite³ | Test tube | UI_JPL (1 drop)⁴ | Olive green to black |

¹10 g Chloroform in 10 g Ethanol and 200 g distilled water.
²0.25 ml Nitromethane and 1.50 ml distilled water.
³Solution in water.
⁴1 drop of universal pH indicator (0.36 g Phenolphthalein, 0.18 g methyl red, 0.43 g bromothymol blue, 55 g ethanol, 30 g distilled water and sodium hydroxide in water solution) and 1.50 ml distilled water.

Example numbers 24 & 25: Emulsification of water-insoluble
organic liquids as emulsion aids and vegetable oils¹.

| | | | | Stability |
|---|---|---|---|---|
| Example | Vegetable | | | after 6 |
| Number | oil | Emulsion aid | Sonication change | days⁴ |
| 24 | Castor oil | Diethyl | Colorless to white | Yes |
| | | phthalate² | opaque emulsion | |
| 25 | Castor oil | Benzyl | Colorless to white | Yes |
| | | ether³ | opaque emulsion | |

¹The experiments were carried out in 2 ml glass vials. Four glass beads were used as an agitation aid.
²Castor oil was added into diethyl phthalate in 5%, 10%, 15%, 20% 30% and 40%. Three drops of these mixtures were added to 1.5 ml distilled water.
³Castor oil was added into benzyl ether in 8:2, 1:1 and 4:8. Three drops of these mixtures were added into 1.5 ml distilled water.
⁴Stability of the emulsion at room temperature after 6 days.

Example numbers 26 to 29: Stability of emulsion of vegetable oils
and organic liquids as emulsion aids formed upon sonication¹.

| | | | Quantity | | | Stability |
|---|---|---|---|---|---|---|
| Example | Vegetable | Emulsion | of 1:1 | Sonication | Stability at | at |
| Number | oil | aid | ratio² | change | RT³ | 50° C.⁴ |
| 26 | Castor oil | Benzyl | 0.25 ml | Colorless to | Yes | Yes |
| | | ether | | white opaque | | |
| | | | | emulsion | | |
| 27 | Castor oil | Benzyl | 0.50 ml | Colorless to | Yes | Yes |
| | | ether | | white opaque | | |
| | | | | emulsion | | |
| 28 | Castor oil | Benzyl | 0.75 ml | Colorless to | Yes | Yes |
| | | ether | | white opaque | | |
| | | | | emulsion | | |
| 29 | Castor oil | Benzyl | 1.00 ml | Colorless to | Yes | Yes |
| | | ether | | white opaque | | |
| | | | | emulsion | | |

¹The experiments were carried out in 2 ml glass vials. Four glass beads were used as an agitation aid.
²After adding different amounts of the 1:1 ratio of castor oil and benzyl ether, the remainder of the glass vial was filled with distilled water.
³Stability of the emulsion formed after sonication at room temperature after 6 days.
⁴Stability of the emulsion formed after sonication, being left in 50° C. oven for 3 days and then at room temperature for an additional 6 days.

Example numbers 30: Emulsion formation
after freezing for 2 weeks¹.

| | | | Quantity | |
|---|---|---|---|---|
| Example | Vegetable | Emulsion | of 1:1 | |
| Number | oil | aid | mixture | Sonication change |
| 30 | Castor oil | Benzyl | 0.25 ml | Colorless to white |
| | | ether | | opaque emulsion |

¹The experiment was carried out in a glass vial with 1 ml distilled water. Four glass beads were used as an agitation aid.

Example numbers 31 to 33: Stability
upon vigorous shaking on a shaker¹.

| | | | Quantity | |
|---|---|---|---|---|
| Example | Vegetable | Emulsion | of 1:1 | |
| Number | oil | aid | mixture² | 1 hour on a shaker³ |
| 31 | Castor oil | Benzyl ether | 0.25 ml | No emulsion formation |
| 32 | Castor oil | Benzyl ether | 0.50 ml | No emulsion formation |
| 33 | Castor oil | Benzyl ether | 0.75 ml | No emulsion formation |

¹The experiments were carried out in glass 2 ml vials. Four glass beads were used as an agitation aid.
²After adding different amounts of the 1:1 ratio of castor oil and benzyl ether, the remainder of the glass vial was filled with distilled water.
³Stability of the no emulsion formation after vigorous shaking at room temperature after 6 hours.

Example numbers 34 to 36: Color
change and dispersion formation¹.

| Example | Vegetable | Emulsion | | Sonication |
|---|---|---|---|---|
| Number | oil | aid | Dye | color change |
| 34 | Castor | Benzyl | Rose Bengal | Colorless to pink |
| | oil | ether | lactone | dispersion |
| 35 | Castor | Benzyl | Gallocyanine | Light purple to |
| | oil | ether | | black dispersion |
| 36 | Castor | Benzyl | Oil red EGN | Colorless to red |
| | oil | ether | | dispersion |

¹The experiments were carried out in test tubes where 0.25 ml of 1:1 mixture of castor oil and benzyl ether was added to a particle of dyes dissolved in 2 ml distilled water. Three glass beads were used as an agitation aid.

Example numbers 37 and 38: Barcode
readable ultrasonic indicator.

| | | | Barcode |
|---|---|---|---|
| Example | | Sonication color | readability after |
| Number | Mixture | change | sonication |
| 37 | Castor oil and | Colorless to opaque | Yes |
| | diethyl phthalate¹ | white emulsion | |
| 38 | Nitrazine yellow | Black to yellow | Yes |
| | and chloroform² | | |

¹A clear 1:1 mixture of diethyl phthalate and castor oil was added to water in a test tube with a black barcode printed on clear plastic film and applied on the test tube. The barcode was unreadable before sonication. After sonication, the mixture formed an opaque white emulsion and the barcode was readable from the front. The barcode was not visible and hence not readable from the other side of the test tube.
²A solution of nitrazine yellow and chloroform was added to a test tube with a clear barcode label on it. The color before sonication was black and the barcode was unreadable by a barcode reader. After sonication the solution turned yellow and the barcode was readable. The barcode was printed on a clear polyester film with adhesive and applied on to the test tube but it can also be printed on the container.

Example 39: Use of a water-soluble additive
to minimize shaking after sonication¹.

| Example | | Sonication | Color visibility |
|---|---|---|---|
| Number | Mixture | color change | after sonication² |
| 39 | 2 drops Benzyl ether, 2 | Colorless to | Yes |
| | drops glycerin, 1 drop | opaque white | |
| | almond oil in 1 ml distilled | emulsion | |
| | water in a 2 ml plastic | | |
| | centrifuge tube. | | |

¹The emulsion formed in Examples 26-36 required shaking with a hand to get uniform white emulsion. Addition of a water-soluble organic liquid such as glycerin did not require the shaking after sonication.
²The sticker could be of any color, message or a barcode.
3. FIG. 6 is a presentation of photos of the centrifuge having a blue sticker adhered outside the plastic vial before (A) and after (B) sonication. The sticker could be of any color, message or a barcode.

Example number 40: An ultrasonic indicator where
a dye and an activator change colors¹.

| Example | Dye | | | Sonicated | Sonicated |
|---|---|---|---|---|---|
| Number | solution | Activator | Control | 5 minutes | 15 minutes |
| 40 | MGCB² | 1-Nitroso-2- | Clear | Clear green | Clear dark |
| | | naphthol³ | yellow- | | green |
| | | | green | | |

¹The experiment was carried out in a plastic vial where 1 drop of dye solution was added to 1 ml activator solution.
²0.01 g Malachite green carbinol base (MGCB) in 10 ml distilled water.
³0.20 g 1-Nitroso-2-naphthol in 200 ml distilled water.

Example numbers 41 and 42: An ultrasonic indicator where a dye, an
oil and an organic liquid as emulsion aid form a colored emulsion¹.

| Example | Dye | Emulsion | | | Sonicated | Sonicated 15 |
|---|---|---|---|---|---|---|
| Number | solution | aid | Nut oil | Control | 5 minutes | minutes |
| 41 | MGHCI² | Benzyl | Almond | Clear | Opaque³ | Opaque³ light |
| | | ether | oil | blue | blue | blue |
| 42 | MGO⁴ | Benzyl | Almond | Clear | Opaque³ | Opaque³ light |
| | | ether | oil | blue | blue | blue |

¹The experiment was carried out in a 2 ml plastic vial where 1 drop Benzyl ether, 1 drop Almond oil and 2 drops dye solution were added to 1.50 ml distilled water.
²0.01 g Malachite green hydrochloride in 10 ml distilled water, 1 ml of previous solution in 9 ml distilled water.
³Emulsified opaque.
⁴0.01 g Malachite green oxalate in 10 ml distilled water, 1 ml of previous solution in 9 ml distilled water.

Example number 43: An ultrasonic indicator where a dye, an activator, an oil,
an organic liquid as emulsion aid and glycerin form a colored emulsion¹.

| Example | Dye | | Emulsion | | | | Sonicated | Sonicated |
|---|---|---|---|---|---|---|---|---|
| Number | solution | Activator | aid | Nut oil | | Control | 5 minutes | 15 minutes |
| 43 | MGCB² | 35DNBA³ | Benzyl | Almond | Glycerin | Clear | Opaque⁴ | Opaque⁴ |
| | | | ether | oil | | blue | blue | light blue |

¹The experiment was carried out in a plastic vial were 0.75 ml dye solution, 0.75 ml indicator solution, 1 drop Benzyl ether, 1 drop Almond oil and 1 drop glycerin were added. This also worked for the same amount of dye solution and indicator solution along with 2 drops benzyl ether, 2 drops 2 almond oil and 2 drops glycerin.
²0.10 g Malachite green carbinol base in 100 ml distilled water.
³0.10 g 3,5-Dinitrobenzoic acid in 100 ml distilled water.
⁴Emulsified opaque.

Example numbers 44 to 47: An ultrasonic indicator where a dye, an activator
and an organic liquid as emulsion aid form a colored emulsion¹.

| | | | Amount of | | | |
|---|---|---|---|---|---|---|
| Example | Dye | | emulsion | | Sonicated | Sonicated |
| Number | solution | Activator | aid | Control | 5 minutes | 15 minutes |
| 44 | MGCB² | 1-Nitroso- | 1 drop | Clear | Opaque⁴ | Opaque⁴ |
| | | 2- | Benzyl ether | green | yellow | yellow |
| | | naphthol³ | | | green | |
| 45 | MGCB- | 1-Nitroso- | 2 drops | Clear dark | Opaque⁴ | Opaque⁴ |
| | IPA⁵ | 2- | Benzyl ether | blue | green | light yellow |
| | | naphthol⁶ | | | blue | green |
| 46 | MGCB- | 1-Nitroso- | 2 drops | Clear dark | Opaque⁴ | Opaque⁴ |
| | W-IPA⁷ | 2- | Benzyl ether | blue | green | yellow |
| | | naphthol⁶ | | | | |
| 47 | MCCB² | 1-Nitroso- | 2 drops | Clear | Opaque⁴ | Opaque⁴ |
| | | 2- | Benzyl ether | green | yellow | yellow |
| | | naphthol⁶ | | | | |

¹The experiment was carried out in a plastic vial were 6 drops of dye solution and 1 drop organic liquid is added to 1 ml activator solution.
²6 drops 0.01 g Malachite green carbinol base in 10 ml distilled water.
³0.20 g 1-Nitroso-2-naphthol in 200 ml distilled water.
⁴Emulsified opaque.
⁵6 drops 0.20 g Malachite green carbinol base in 100 g isopropyl alcohol.
⁶Oversaturated solution of 1-Nitroso-2-naphthol in distilled water.
⁷3 drops 0.20 g Malachite green carbinol base in 50 g distilled water and 50 g isopropyl alcohol.

Example numbers 48 and 49: An ultrasonic indicator where
a dye, an oil and an organic liquid as emulsion aid form a
colored emulsion with glycerin and RS710¹.

| Example | | | | Sonicated |
|---|---|---|---|---|
| Number | Dye solution² | BEAO³ | Control | 15 minutes |
| 48 | Acid blue 120 | 3 drops | Clear blue | Opaque⁴ gray |
| 49 | Gallocyanine | 3 drops | Clear purple | Opaque⁴ pink |

¹The experiment was carried out first in a test tube, where particles of dye were diluted with GRS solution (80 g glycerin with 5 g Rhodia Rhodafac RS710 in 4 liters of distilled water). Then, in plastic vials, 1 ml of previous solution was added to 3 drops of BEAO solution.
²Particles of dye diluted with GRS solution until light color was achieved.
³100 g Benzyl ether and 100 g almond oil solution.
⁴Emulsified opaque.

The invention has been described with reference to preferred embodiments without limit thereto. One of skill in the art would realize additional embodiments which are described and set forth in the claims appended hereto.

1. An ultrasonic indicating device comprising:
a container comprising water, an oil and at least one composition selected from the group consisting of:
a water insoluble organic liquid as an emulsion aid and an oi additive;
wherein said composition does not form an emulsion upon mechanical shaking but forms an emulsion upon ultrasonification.

2. The ultrasonic indicating device of claim 1 wherein said emulsion aid is selected from the group consisting of benzyl ether, 4-(benzyloxy)phenol, bis (2-ethylhexyl) adipate, bis (2-ethylhexyl) sebacate, cyclopentanone, dibutyl adipate, dibutyl diacetate, diethyl malate, diethyl malonate, diethyl oxalate, diethyl phthalate, diethyl succinate, diethyl l-tartrate, dimethyl carbonate, dimethyl maleate, dimethyl malonate, dimethyl phthalate, dioctyl phthalate, ethylene carbonate, ethylene glycol diacetate, candelilia wax, bees wax, paraffin wax, paraffin wax, benzyl n-butyl phthalate, dibutyl phthalate, triethyl phosphate, triphenyl phosphate, tris (2-butoxy ethanol) phosphate, tris (2-chloroethyl) phosphate, diethyl phthalate, acetonitrile, 1-butoxy-2-propanol, 1,4-dioxane, 1,3-dioxolane, ethanol, 2-ethoxyethanol, glycerin, ethylene glycol mono-butyl ether acetate, isopropanol, methanol, 1-methoxy-2-propanol and nitromethane.

3. The ultrasonic indicating device of claim 1 wherein said emulsion aid is selected from the group consisting of substituted or unsubstituted aliphatic or aromatic amides, alcohols, esters, nitroalkanes, aldehydes, butyraldehyde, carbonates, aromatic alcohols, aromatic phenols, amines, ether-esters, alcohol-esters, acids, ketones, ketone-esters and lactones or mixture thereof.

4. The ultrasonic indicating device of claim 3 wherein said emulsion aid is selected from the group consisting of acetamide, dimethylformamide and chloroacetamide, amyl alcohol, hexyl alcohol, dichloropropanol, methylpropionate, amylformate, diethyl maleate, ethylene glycol diacetate, ethylsalicylate, triacetin, nitropropane, butyraldehyde, diethylcarbonate, propylene carbonate, dihydroxy benzene, benzyl alcohol, phenol, diethanolamine, dimethylpyridine, cyclohexane diamine, ethoxyethylacetate, trioxane, tetraethylene glycol dimethylether, benzyl ether, phenylether, propylene glycol ethylether acetate, propylene glycol butylether, ethylene glycol monacetate, glutaric acid, isobutyric acid, mandelic acid, toluene sulfonic acid, methylethylketone, hydroxyacetophenone, methylacetoacetate, propiolactone butyrolactone and methylpyrrolidone.

5. The ultrasonic indicating device of claim 1 comprising 0.1 g-0.5 g of said oil per 2 ml of water.

6. The ultrasonic indicating device of claim 1 wherein said oil is selected from the group consisting of almond oil, avocado oil, black cumin seed oil, canola oil, coconut oil, refined castor oil, corn oil, flax seed oil, jojoba oil, mineral oil, extra virgin olive oil, rosehip oil, safflower oil, sesame oil, cottonseed oil, palm oil, peanut oil, rapeseed oil, soybean oil, sunflower oil, beech nut oil, Brazil nut oil, cashew oil, hazelnut oil, macadamia oil, mongongo nut oil, pecan oil, pine nut oil, pistachio oil, walnut oil, pumpkin seed oil, açaí oil, blackcurrant seed oil, borage seed oil, evening primrose oil, amaranth oil, apricot oil, apple seed oil, babassu oil, ben oil, Borneo tallow nut oil, cape chestnut oil, carob pod oil, cocoa butter, cocklebur oil, and cohune oil.

7. The ultrasonic indicating device of claim 1 wherein said additive comprises a water soluble organic liquid.

8. The ultrasonic indicating device of claim 7 wherein said water soluble organic liquid is selected from the group consisting of ethanol, isopropanol and glycerin.

9. The ultrasonic indicating device of claim 1 wherein said additive is a halo compound.

10. The ultrasonic indicating device of claim 9 wherein said halo compound is selected from the group consisting of 1-chloro-1-nitropropane, chloroform, carbon tetrachloride, chloroacetic acid, chloropropionic acid, ethyl trichloroacetate, heptachloropropane, hexachlorocyclohexane, methyl trichloroacetimidate, pentachloroethane, tetrachloroethane, trichloroethanol, trichloromethyl benzyl acetate, trichloromethyl propanol hydrate, trichloropropane, trichloroacetamide, trichloroacetic acid, trichloroethaneisocyante, trichloromethylbenzylacetate, trichloromethylpropanol, trichloropropane, chlorinated paraffins, halo polymers, such as polyvinyl chloride, polyvinylidene chloride, polyepichlorhydrin and halogenated polymers, such as chlorinated polyisoprene, chlorinated polyvinylchloride, 1,1-bis [p-chlorophenyl]-2,2,2-trichloroethane; 1,1-bis [p-methoxyphenyl]-2,2,2-trichloroethane; 1,2,5,6,9,10-hexabromo cyclododecane; 1,10-dibromodecane; 1,1-bis [p-chlorophenyl]-2,2-dichloroethane: 4,4′-dichloro-2-(trichloromethyl) benzhydrol; hexachlorodimethyl sulfone; 2-chloro-6(trichloromethyl) pyridine; 0,0-diethyl-0-(3,5,6-trichloro-2-pyridyl) phosphorothionate; 1,2,3,4,5,6-hexachloro cyclohexane; N(1,1-bis [p-chlorophenyl]-2,2,2-trichloroethyl) acetamide; tris [2,3-dibromopropyl]isocyanurate; 2,2-bis [p-chlorophenyl]-1,1-dichloroethylene and tris [trichloromethyl]s-triazine.

11. The ultrasonic indicating device of claim 9 wherein said halo compound is selected from the group consisting of chloroform, dichloroethane, ethyl trichloroacetate, hexachloroacetone, trichloroaetamide, 1,1,1-trichloroethane, trichloromethylphenyl carbinyl acetate, and tris(2-chloroethyl)phosphate.

12. The ultrasonic indicating device of claim 1 wherein said additive is a nitro-compound.

13. The ultrasonic indicating device of claim 12 wherein said nitro-compound is selected from the group consisting of substituted and unsubstituted aliphatic, aromatic and cyclic nitro-compounds, inorganic nitrates, and inorganic nitrite.

14. The ultrasonic indicating device of claim 13 wherein said nitro-compound is selected from the group consisting of nitrophenols, nitrotoluenes, nitronaphthalenes, nitroanisidines, nitrobenzenes, chloronitrobenzenes, amyl nitrite, chloronitropropane, diethylene glycol nitrates, ethylene glycol nitrates, ethyl nitrate, nitroglycerins, nitroso-compounds, nitrocellulose, sodium nitrate, ammonium nitrate, sodium nitrite, 2,2′-azodiisobutyronitrile, 3,5-dinitrobenzoic acid, dinitronaphthalene, 1,8-dinitronaphthalene, 3,5-dinitrobenzoic acid, 2,4-dinitro-1-naphthol, disodium 1-nitroso-2-naphthol-3,6-disulfonate, 4-hydroxy-3-nitroso-1-naphthalene sulfonic Acid, 4-nitrobenzoic acid, 5-nitroguaiacol, 4-nitrophenol, 4-nitrosophenol, sodium salt, 1-nitroso-2-naphthol, 2-nitroso-1-naphthol, 4-nitrosophenol and 4-nitrotoluene.

15. The ultrasonic indicating device of claim 1 wherein said composition further comprises an agitation aid.

16. The ultrasonic indicating device of claim 15 wherein said agitation aid is selected from the group consisting of Timeset™ 304 stainless steel woven wire 200 mesh screen; Red Devil™'s 0 fine steel wool pad, 00 very fine steel wool pad, and 000 extra fine steel wool pad; stainless steel scrubbing scouring pad sponge; Sophisti™ clean stainless steel microfiber cloth; crafts black beads; crafts silver beads; Darice™ no hole beads; Pandahall™ beads; zirconium beads; glass beads; alumina beads; q-bead glass 1.2 mm beads; q-bead glass 3 mm beads; washed sand; white quartz powder; German glass glitter; hollow cylinder glass; WGV™ white coarse sand; silica gel 70-230 mesh 60 Angstroms; white quartz sand; Balabead™ glass seed beads beige 0.6 mm; transparent 2 mm and pearlized white 2 mm beads; Czech bugle beads 7 mm; Estes™ gravel products aes06606; marine sand black; Podzly™ white decorative bulk craft sand; glass q-beads 0.8 mm; royal ram natural white marble decorative real sand; rock shed tin oxide polish; and Quackenbush™ zirconium silicate 1.0 mm.

17. The ultrasonic indicating device of claim 1 wherein said composition comprises no surfactant.

18. The ultrasonic indicating device of claim 1 wherein said composition further comprises 0.001 to 0.01 wt % surfactant.

19. The ultrasonic indicating device of claim 18 wherein said surfactant is selected from the group consisting of Brij 72, Igepal co-990, Pluronic F68, ammonium laurate, calcium oleate, polyethylene oxide with 7-8 repeat units, tert-octylphenol, sodium oleate, tin oleate, zinc oleate and Rhodafac RS710.

20. The ultrasonic indicating device of claim 1 wherein said additive is an inorganic compound.

21. The ultrasonic indicating device of claim 20 wherein said inorganic compounds are selected from the group consisting of ammonium acetate, ammonium bromide, ammonium carbamate, ammonium carbonate, ammonium chloride, ammonium dihydrogen phosphate, ammonium ferrocyanide (ii) hydrate, ammonium iron (IIII) citrate, ammonium iron (III) oxylate hydrate, ammonium iron (III) sulfate dodecahydrate, ammonium iron (III) sulfate hexahydrate, ammonium sulfate, ammonium sulfite monohydrate, ammonium thiocyanate, ammonium thiosulfate, alumina, aluminum acetylacetonate, aluminum ammonium sulfate dodecahydrate, aluminum chloride hexahydrate, aluminum hydroxide, aluminum nitrate nonahydrate, aluminum sulfate hexadecahydrate, aluminum sulfate octadecahydrate, benzeneboronic acid, borane-tert-butylamine, borane dimethylamine, boric acid, boric acid tri-n-butyl ester, calcium acetate monohydrate, calcium acetyl acetonate hydrate, calcium bromide anhydrous, calcium bromide monohydrate, calcium chloride, calcium ferrocyanide, calcium hydroxide, calcium orthophosphate, calcium sulfide, copper, copper (II) acetate monohydrate, copper (II) acetylacetonate hydrate, copper (II) bromide, copper (I) chloride, copper (II) chloride hydrate, copper pyrophosphate, copper (II) sulfate pentahydrate, copper (I) thiocyanate, cupric benzoate, lithium acetylacetonate, lithium tetra-borate, lithium chloride, lithium formate monohydrate, lithium hydroxide monohydrate, ferric acetylacetonate, iron (II) bromide, iron (II) chloride tetrahydrate, iron (III) chloride hexahydrate, ferric ferrocyanide, ferrocene, p-gluconic acid, iron (II) salt dihydrate, ferric salicylate, iron (II) sulfate heptahydrate, iron (iii) sulfate pentahydrate, magnesium acetate tetrahydrate, magnesium chloride hexahydrate, magnesium oxide, magnesium sulfate heptahydrate, nickel, nickel (IIi) bromide, nickel (II) chloride, nickel sulfate, potassium acetate, potassium benzoate, potassium bromide, potassium carbonate, potassium chloride, potassium ferrocyanide (II) trihydrate, potassium ferricyanide, potassium formate, potassium iodide, potassium nitrate, potassium phosphate, dibasic trihydrate, tri-potassium phosphate, potassium pyrophosphate, potassium sodium tartrate tetrahydrate, sodium acetate, sodium acetylacetonate, sodium bromide, sodium carbonate, sodium chloride, sodium cyanate, sodium dihydrogen phosphate, sodium diethyldithiocarbamate trihydrate, sodium fluoroborate, sodium hexametaphosphate, sodium iodide, sodium metasilicate, sodium nitrate, sodium nitrite, sodium oxalate, sodium thiosulfate pentahydrate, sodium phosphate, dibasic, sodium sulfate anhydrous, sodium sulfite anhydrous, sodium tetraborate, sodium thiocyanate, sodium trimetaphosphate, sodium tripolyphosphate, tin (II) bromide, tin (II) 2-ethylhexanoate, zinc acetate dihydrate, zinc acetylacetonate hydrate, zinc bromide, zinc chloride, zinc iodide, zinc sulfate heptahydrate, zinc sulfide and 3-chlorophenylboronic acid.

22. The ultrasonic indicating device of claim 1 wherein said additive comprises solid organic compounds and said composition comprises up to 5 wt % of said solid organic compounds.

23. The ultrasonic indicating device of claim 22 wherein said solid organic compounds are selected from the group consisting of 4-acetamidophenol, acetone oxime, 2-amino-p-cresol, 4-tert-amylphenol, ascorbic acid, azodicarbonamide, benzilic acid, 2-(2h-benzotriazol-2-yl)-6-dodecyl-4-methylphenol, benzotriazole, benzenesulfonic acid, benzyl sulfoxide, 2-benzoylbenzoic acid, 4,4-bis (4-hydroxyphenyl)-valeric acid, tert-butylhydroquinone, caffeine, trans-cinnamic acid, 2,6-di-tert-butyl-4-methylphenol, 2,7-dihydroxynaphthalene, 4,5-dihydroxy-2,7-naphthalenedisulfonic acid, 4,5-dihydroxy-2,7-naphthalenedisulfonic acid disodium salt, 6,7-dihydroxy-2-naphthalenesulfonic acid, sodium salt hemihydrate, dimethylglyoxime, diphenylamine, 4-diazodiphenylamine sulfate, diazoaminobenzene, dinitronaphthalene, 1,8-dinitronaphthalene, 2,4-dinitrodiphenylamine, ethylenediaminetetraacetic acid, ethylenediaminetetraacetic acid iron (iii) sodium salt hydrate, ethyl gallate, gallic acid monohydrate, gallic acid stearyl ester, gluconic acid, sodium salt (sodium gluconate), 5-gluconolactone, glycerophosphate (calcium salt), 2-hydroxycinnamic acid, 4-hydroxycoumarin, 2-hydroxy-4-methoxybenzophenone7-hydroxy-4-methyl coumarin, 2-hydroxy-1,4-naphthalene, hydroquinonesulfonic acid potassium salt, lauryl gallate, dl-malic acid, mandelic acid, methylhydroquinone, methyl 3,4,5-trihydroxy-benzoate, 5-nitroguaiacol, octadecylamine, 1,10 phenanthroline, phenothiazine, phenylboronic acid, n-phenyl-2-naphthylamine, 4-phenylphenol, phytic acid 50 wt % solution in water, poly (ethylene glycol) dimethyl ether molecular weight˜500, propyl gallate, pyrogallic acid, salicylic acid, salicylamide, salicylaldoxime, tetrabutyl ammonium hydrogen sulfate, tetrabutylphosphonium bromide, tannoform, tetra-n-hexylammoinium bromide, tetrahexylammonium bromide, p-toluenesulfonic acid monohydrate, trichloroacetamide, trimethylhydroquinone, 2,3,4-trihydroxybenzophenone, trichloromethylphenyl carbinyl acetate, triethanolamine borate, 2,2′,4,4′-tetrahydroxy-benzophenone, tris (hydroxymethyl) aminomethane, 1,1,1-tris(4-hydroxy-phenyl)ethane, resorcinol, rutin hydrate, trans-stilbene, urea, glyoxal trimeric dihydrate, 2-diazo-1-naphthol-5-sulfonic acid sodium salt monohydrate, 1-diazo-2-naphthol-4-sulfonic acid, fast blue base B, fast orange base GC, fast red base B, fast scarlet base G, 4-hydroxy-3-nitrobenzoic acid, 4-nitrocinnamic acid, 2′2-biphenol, citric acid, 1,12-diaminododecane, 4-diazo-3-methoxydiphenylamine sulfate, 4,5-dihydroxy-1,3-benzene disulfonic acid disodium salt hemihydrate, 1,6-dihydroxy naphthalene, 3,6-dihydroxy naphthalene-2,7-disulfonic acid disodium salt, ethylenediaminetetraacetic acid tetrasodium salt dihydrate, magnesium stearate, 4-4′oxydibenzenesulfonyl hydrazide, tetrabutylammonium bromide, 2-acetylphenothiazine, ascorbic acid 6-palmitate and benzamide.

24. The ultrasonic indicating device of claim 1 wherein said additive a pH indicator.

25. The ultrasonic indicating device of claim 24 wherein said pH indicator is selected from the group consisting of Acid alizarin violet N, acid blue 89, acid blue 92, acid fuchsin, acridine, alizarin red, alizarin red S, alizarin yellow GG, alizarin yellow R, alkali blue, 9-amino-6-chloro-2-methoxyacridine, 5-aminosalicylic acid, anilinesulfonephthalein, anthranilic acid, aurin, benzaurin, benzopurpurin 4B, brilliant green, brilliant yellow, bromochlorophenol blue, bromochlorophenol blue-sodium salt, bromocresol green, bromocresol green sodium salt, bromocresol purple, bromocresol purple sodium salt, bromophenol blue, bromophenol blue sodium salt, bromophenol red, bromothymol blue, bromothymol blue sodium salt, bromoxylenol blue, calcein, calmagite, carbazol yellow, 5-carboxyfluorescein, 6-carboxyfluorescein, 5-carboxyfluorescein diacetate, 6-carboxyfluorescein diacetate, carboxyfluorescein diacetate succinimidyl ester, 5-carboxynaphthofluorescein, 6-carboxynaphthofluorescein, 5-carboxynaphthofluorescein diacetate, carboxy snafl 1, carboxy snafl 2, carvacrolphthalein, chlorophenol red, chlorophenol red-sodium salt, chrome orange GR, chrysoidin, clayton yellow, Congo red, coumarin, o-cresolbenzein, o-cresolphthalein, o-cresolphthalein complexon, m-cresol purple, m-cresol purple-sodium salt, o-cresol red, o-cresol red-sodium salt, crystal violet, curcumin, dichlorofluorescein, 6,7-dihydroxycoumarin, 3,6-dihydroxyphthalimide, 4-dimethylamino-2-methylazobenzene, dinitrocresol, alpha-dinitrophenol, beta-dinitrophenol, gamma-dinitrophenol, epsilon-dinitrophenol, delta-dinitrophenol, 2,4-dinitrophenylhydrazine, dinitrothymol, direct blue 72, dixylenolphthalein, eosin Y, erythrosin B, esculetin, ethyl-bis(2,4-dinitrophenyl)-acetate, ethyl green, ethyl orange, ethyl red, ethyl violet, fluorescein, fluorescein diacetate, fluorescein disodium salt, fluorescein-5-isothiocyanate, fluorexon, gallein, gentian violet, gentian violet B, guaiacolphthalein, harmine, hematoxylin, 4-heptadecyl-7-hydroxycoumarin, heptamethoxy red, hexamethoxy red, o-hydroxypheylbenzimidazole, o-hydroxypheylbenzothiazole, o-hydroxypheylbenzoxazole, indigo carmine, indophenol, iodophenol blue, isonitrosothiocamphor, isopicramic acid, lacmoid, lanacyl violet BF, luminol, lysosensor blue DND 167, lysosensor blue DND 192, lysosensor green DND 189, lysosensor yellow/blue DND 160, magdala red, malachite green, martius yellow, mesalamine, Metanil yellow, 2-methoxybenzaldehyde, 4-methylesculetin, methyl green, methyl orange, methyl purple, methyl red, methyl red sodium salt, 4-methylumbelliferone, methyl violet, methyl yellow, alpha-naphthoic acid, beta-naphthol, naphthol AS, alpha-naphtholbenzein, alpha-naphtholphthalein, alpha-naphthylamine, beta-naphthylamine, alpha-naphthyl red, neutral red, Nile blue, nitramine, nitrazine yellow, p-nitrobenzhydrazide, p-nitrobenzylcyanide, 4-nitrocatechol, o-nitrophenol, m-nitrophenol, p-nitrophenol, orange II, orange III, orange IV, Oregon green 488 carboxylic acid, Oregon green 514 carboxylic acid, Oregon green 488 carboxylic acid diacetate, patent blue V, pentamethoxy red, phenolbenzein, phenolmalein, phenolphthalein, phenolphthalein disodium salt, phenol red, phenol red sodium salt, 4-(phenylazo)-diphenylamine, o-phenylenediamine, p-phenylenediamine, phloxine B, picric acid, pinachrome, poirrier blue, propyl red, pyrogallolphthalein, quinaldine red, quinine, quininic acid, quinoline blue, resazurin, resorcein, resorcinmalein, resorufin, rhodol green, p-rosolic acid, rubrophen, salicyladehyde semicarbazone, salicylic acid, salicyl yellow, solochrome violet RS, sulphan blue, tetrabromophenol blue, tetrabromophenol blue sodium salt, tetrabromophenolphthalein, tetraiodophenolsulfonephthalein, tetryl, thiazol yellow G, thymolbenzein, thymol blue, thymolphthalein, trinitrobenzene, trinitrobenzoic acid, trinitrotoluene, tropaeolin O, tropaeolin OO, tropaeolin OOO, umbelliferone, xylenol blue, xylenol orange and xylenolphthalein.

26. The ultrasonic indicating device of claim 24 wherein said pH indicator is selected from the group consisting of leuco crystal violet, rose Bengal, rose Bengal lactone, methylene violet 3RAX, malachite green carbinol base, xylenol blue, leuco malachite green, pararosaniline base, methyl violet B base, acridine orange base, and leucoquinizarin.

27. The ultrasonic indicating device of claim 1 wherein said additive is a water soluble polymer.

28. The ultrasonic indicating device of claim 27 wherein said water soluble polymer is selected from the group consisting of alginates; hydroxy alkyl cellulose, carrageenan, guar gum, gum agar, gum ghatti, gum karaya, gum tragacanth, locust bean gum, pectin, polyacrylamide, polyacrylic acid, polyvinyl alcohol, polyethylene oxide, polyethylene glycols, polyvinylpyrrolidone, a starch, tamarind gum, xanthan gum, gelatins, and polyethyleneimine.

29. The ultrasonic indicating device of claim 28 wherein said water soluble polymer is carboxy methyl cellulose.

30. The ultrasonic indicating device of claim 1 wherein said composition further comprises at least one of a stabilizer, a thickener, and an anti-oxidant.

31. The ultrasonic indicating device of claim 30 wherein said thickener further comprises at least one of a fumed silica, polyethylene polyvinyl alcohol or partially hydrolyzed polyvinyl alcohol.

32. The ultrasonic indicating device of claim 1 wherein said container is a blister pack.

33. The ultrasonic indicating device of claim 32 wherein said blister pack comprises a transparent film.

34. The ultrasonic indicating device of claim 1 wherein said container is selected from a glass container and a plastic container.

35. The ultrasonic indicating device of claim 34 wherein said container further comprises a seal.

36. The ultrasonic indicating device of claim 34 wherein said container further comprises a septum.

37. The ultrasonic indicating device of claim 1 wherein said container further comprises a readable indicia.

38. The ultrasonic indicating device of claim 37 wherein said readable indicia is a machine readable indicia.

39. The ultrasonic indicating device of claim 37 wherein said readable indicia is selected from a bar code and a QR code.

40. A method of monitoring ultrasonic cleaning comprising:
placing an ultrasonic indicating device in an ultrasonic cleaning device comprising a fluid wherein said ultrasonic indicating device comprises a container comprising water, an oil and at least one composition selected from the group consisting of:
a water insoluble organic liquid as an emulsion aid and an additive; and
applying ultrasonic radiation to said fluid until said composition changes in at least one of color or opacity.

41-81. (canceled)
